(19) United States
(12) Patent Application Publication
(10) Pub. No.: US 2011/0193721 A1
(43) Pub. Date: Aug. 11, 2011

(54) In-vehicle communication apparatus

(75) Inventors: Yoshio Koie, Handa-city (JP); Hiroyasu Ogino, Kariya-city (JP); Shinji Kamiya, Kariya-city (JP); Tatsuya Shintai, Chita-gun (JP)

(73) Assignee: DENSO CORPORATION, Kariya-city (JP)

(21) Appl. No.: 12/931,669

(22) Filed: Feb. 7, 2011

(30) Foreign Application Priority Data
Feb. 10, 2010 (JP) 2010-027559
Jun. 22, 2010 (JP) 2010-141535

(51) Int. Cl. G08G 1/00

(52) U.S. Cl. 340/901

(57) ABSTRACT

An in-vehicle communication apparatus is disclosed. The apparatus includes: a wireless communication device; a vehicle stop state determination section configured to determine whether a vehicle is in a stop state or a not-stop state; a connectibility determination section configured to determine whether wireless communication between the wireless communication device and the mobile communication network is possible or impossible; and a control section configured to cause a notification device to notify notice information when the vehicle is determined to be in the stop state and when the wireless communication is determined to be impossible. The notice information indicates that position of the vehicle in the stop state is within an area where the wireless communication is impossible.

### CROSS REFERENCE TO RELATED APPLICATION

The present application is based on and claims priority to Japanese Patent Applications No. 2010-27559 filed on Feb. 10, 2010 and No. 2010-141535 filed on Jun. 22, 2010, disclosures of which are incorporated herein by reference.

### BACKGROUND OF THE INVENTION

1. Field of the Invention

The present invention relates to an in-vehicle communication apparatus capable of performing wireless communications via a mobile communication network.

2. Description of Related Art

There is known an in-vehicle communication apparatus that transmits a theft notice signal from a wireless communication device to a center apparatus, which is in a service center, via a mobile communication network if vehicle theft occurs, or that starts an engine or locks/unlocks a vehicle door if the wireless communication device receives a remote control signal from a cellular phone, which is carried by a user, via the mobile communication network (see JP-2009-51499A for example).

The in-vehicle communication apparatus can receive and transmit the theft notice signal or the remote control signal if the vehicle is stopped within a communication range of the mobile communication network. In other words, if the vehicle is stopped at an outside of the communication range of the mobile communication network or stopped in a poor reception area (i.e., weak radio wave area), it becomes impossible for the wireless communication device to transmit and receive the theft notice signal and the remote control signal.

Displaying an icon on a navigation screen may be a way to give a user a recognition of whether the vehicle is located within or outside the communication range of the mobile communication network. However, the icon on the navigation screen is small in size. Further, in some cases, the absence of a predetermined operation on the navigation screen may result in undisplay of the icon. For this reason, when vehicle stop position is outside the communication range of the mobile communication network, a user may get away from the vehicle while not recognizing that the vehicle stop position is outside the communication range.

### SUMMARY OF THE INVENTION

The present invention is made in view of the foregoing. It is an objective of the present invention to provide an in-vehicle communication apparatus that can appropriately give a user a recognition that vehicle stop position is within an area where wireless communication between a wireless communication device and a mobile communication network is impossible, when the vehicle stop position is within such an area.

According to an aspect of the present invention, an in-vehicle communication apparatus is provided. The in-vehicle communication apparatus includes: a wireless communication device configured to perform wireless communication via a mobile communication network; a vehicle stop state determination section configured to determine whether a vehicle is in a stop state or a not-stop state; a connectibility determination section configured to determine whether the wireless communication between the wireless communication device and the mobile communication network is possible or impossible; and a control section configured to cause a notification device to notify notice information when the vehicle stop state determination section determines that the vehicle is in the stop state and when the connectibility determination section determines that the wireless communication between the wireless communication device and the mobile communication network is impossible. The notice information indicates that position of the vehicle in the stop state is within an area where the wireless communication between the wireless communication device and the mobile communication network is impossible.

According to the above in-vehicle communication apparatus, when vehicle stop position is outside a communication range of the mobile communication network or is within an poor reception environment area (e.g., a weak radio wave area), the notification device can notify the notice information indicating that the position of the vehicle in the stop state is within an area where the wireless communication between the wireless communication device and the mobile communication network is impossible. Therefore, it is possible to appropriately give a user a recognition that the wireless communication between the wireless communication device and the mobile communication network is impossible at the position of the vehicle in the stop state.

### BRIEF DESCRIPTION OF THE DRAWINGS

The above and other objects, features and advantages of the present invention will become more apparent from the following detailed description made with reference to the accompanying drawings. In the drawings:

FIG. 1 is a functional block diagram illustrating an in-vehicle communication apparatus according to embodiments;

FIG. 2 is a flow chart illustrating a process performed by the in-vehicle communication apparatus according to a first embodiment;

FIG. 3 is a flowchart illustrating a process to be performed by the in-vehicle communication apparatus according to a second embodiment;

FIG. 4 is a flowchart illustrating a process to be performed by the in-vehicle communication apparatus according to a modification the second embodiment;

FIG. 5 is a flowchart illustrating a process to be performed by the in-vehicle communication apparatus according to a third embodiment;

FIG. 6 is a flowchart illustrating a process to be performed by the in-vehicle communication apparatus according to a modification the third embodiment;

FIG. 7 is a flowchart illustrating a process to be performed by the in-vehicle communication apparatus according to a fourth embodiment;

FIG. 8 is a functional block diagram illustrating an in-vehicle communication apparatus according to a fifth embodiment; and

FIG. 9 is a flowchart illustrating a process to be performed by the in-vehicle communication apparatus according to the fifth embodiment.

### DETAILED DESCRIPTION OF EMBODIMENTS

### First Embodiment

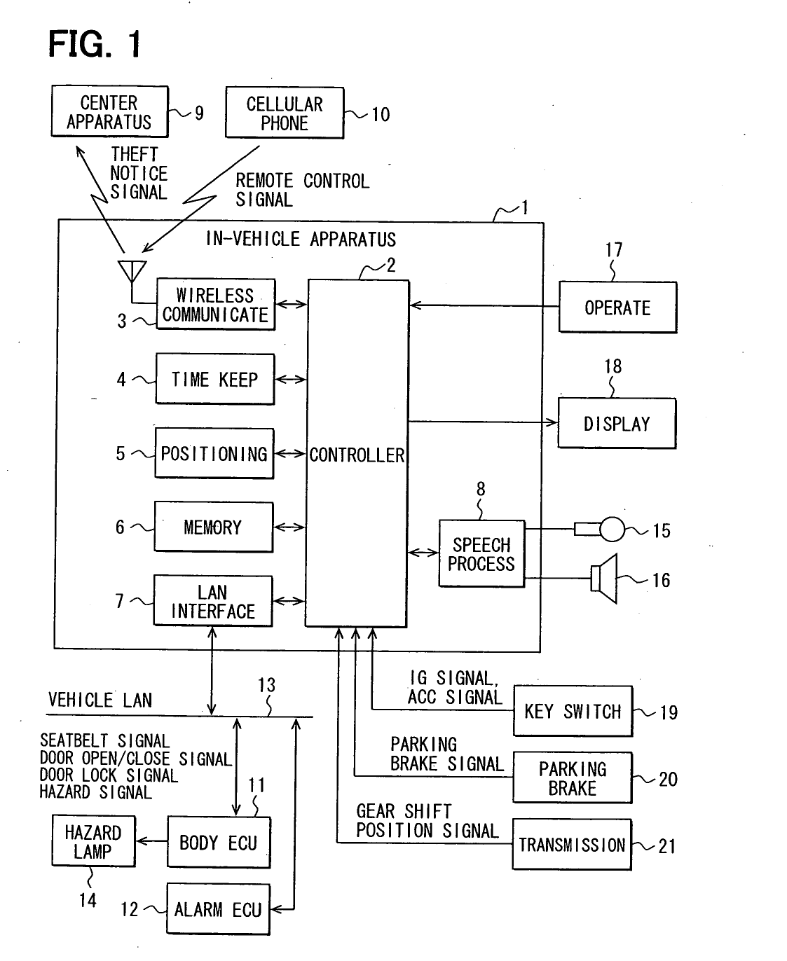

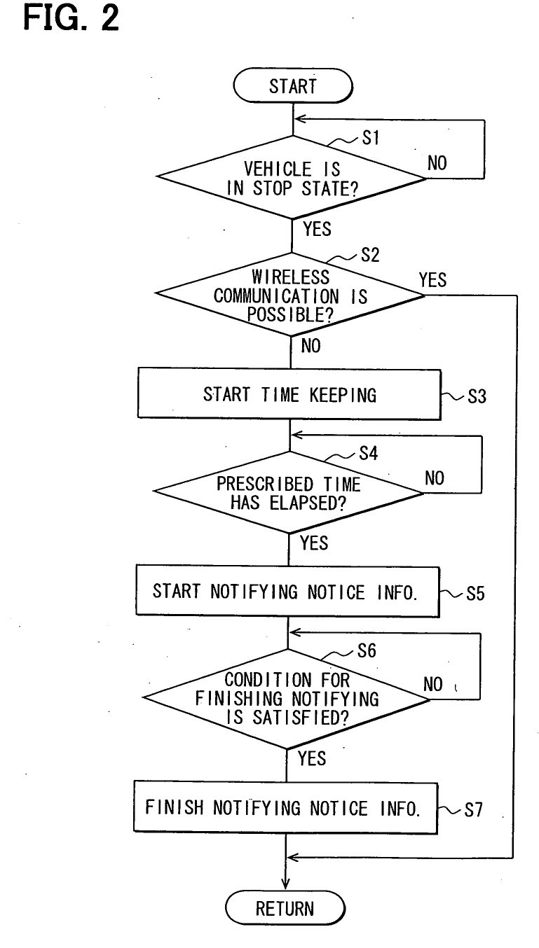

A first embodiment of the present invention will be described below with reference to FIG. 1 and FIG. 2. FIG. 1 is a functional block diagram illustrating an in-vehicle communication apparatus 1. The in-vehicle communication apparatus 1 is mountable to a vehicle and includes a controller 2, a wireless communication device 3, a time keeper device 4, a positioning device 5, a memory device 6, a LAN transmission reception device 7 and a speech processing device 8. The controller 2 can act as a vehicle stop state determination portion or section, a connectibility determination portion or section, and a control portion or section. The wireless communication device 3 can act as a wireless communication portion or section. The positioning device 5 can act as a vehicle position acquisition portion or section. The memory device 6 can act as a vehicle position history storage section or portion, and a registered point storage portion or section.

The controller 2 includes a microcomputer as a main component. The microcomputer includes a CPU (central processing memory), a RAM (random access memory), a ROM (read-only memory) and the like. The controller 2 controls generally all of operations of the in-vehicle communication apparatus 1.

The wireless communication device 3 performs wireless communication with a center apparatus 9 installed in a service center or a cellular phone 10 carried by a user via a mobile communication network. For example, when the controller 2 determines that vehicle theft etc. occurs, the controller 2 causes the wireless communication device 3 to transmit a theft notice signal to the center apparatus 9 via the mobile communication network. When the controller determines that the wireless communication device 3 receives a remote control signal from the cellular phone 10 via the mobile communication network, the controller 2 starts an engine, or locks or unlocks a door of the vehicle.

The time keeper device 4 starts time keeping in response to receiving a time keeping start signal from the controller 2. When a prescribed time has elapsed since the time keeping was started, the time keeper device 4 outputs a time keeping finish signal to the controller 2.

The positioning device 5 calculates parameters in GPS signals received from GPS satellites, acquires position of the vehicle and outputs the acquired position of the vehicle to the controller 2 when a vehicle position acquisition signal is inputted to the positioning device 5 from the controller 2.

The LAN transmission reception device 7 is connected with various ECUs mounted to the vehicle such as a body ECU 11, an alarm ECU 12 and the like via an in-vehicle LAN 13. In the present embodiment, the body ECU 11 outputs a seatbelt signal indicating whether a seatbelt is fastened or unfastened, a door open/close signal indicating whether a door is open and closed, and a door lock signal indicating whether the door is in a locked state or an unlocked state. When the LAN transmission reception device 7 receives the seatbelt signal, the door open/close signal, the door lock signal or the like via the in-vehicle LAN 13, the LAN transmission reception device 7 inputs the received signal to the controller 2. When the LAN transmission reception device 7 receives a hazard signal from the controller 2, the LAN transmission reception device 7 transmits the hazard signal to the body ECU 11 via the in-vehicle LAN 13. When the body ECU 11 receives the hazard signal from the LAN transmission reception device 7, the body ECU 11 causes a hazard lamp 14 to blink on and off. The hazard lamp 14 can act as a notification device, section or portion. For example, the hazard lamp 14 can act as a second notificator configured to notify notice information to an outside of the vehicle.

The speech processing device 8 performs sound processing on outgoing speech inputted via a microphone 15, and performs sound processing on incoming speech, which is to be outputted from a speaker 16. When receiving a speech output command signal from the controller 2, the speech processing device 8 causes the speaker 16 to output speech information in accordance with the speed output command signal. The speaker 16 can act as a notification device, section or portion. For example, the speaker 16 can act as a first notificator configured to notify notice information to an inside (e.g., compartment) of the vehicle.

An operation device 17 may be provided separately from the in-vehicle communication apparatus 1. The operation device 17 can be operated by a user (e.g., a passenger in the vehicle). When receiving operation by a user, the operation device 17 outputs an operation detection signal indicative content of the received operation to the controller 2. The operation device 17 may include a hard key, a touch panel provided on a display screen on a display device 18, or the like. The operation device 17 can act as an operation portion or section.

The display device 18 may be provided separately from the in-vehicle communication apparatus 1, and may include a liquid crystal display for instance. When receiving a display command signal from the controller 2, the display device 18 presents display information in accordance with the display command signal. The display device 18 can act as a notification device, section or portion. For example, the display device 18 can act as a first notificator configured to notify notice information to an inside (e.g., compartment) of the vehicle.

The memory device 6 stores a variety of information. As a history of the position of the vehicle, the memory device 6 stores the position of the vehicle in past acquired by the positioning device 5. The memory device 6 stores a registered point, which may be registered by user's operation of the operation device 17. In the following, the position of the vehicle may be simply referred to as vehicle position, and the position of the vehicle in past may be simply referred to as past vehicle position, and the position of the vehicle at the present time may be simply referred to as present vehicle position. The maximum number of registered points or vehicle positions storable in the memory device 6 is predetermined. Regarding the vehicle position, if a new vehicle position is to be recorded when the memory device 6 already stores the maximum number of vehicle positions, the oldest vehicle position among the stored vehicle positions is deleted and the new vehicle position is recorded.

A key switch 19 outputs an IG (ignition) signal indicative of an ON state or an OFF state of an IG switch and a ACC (accessory) signal indicative of an ON state or an OFF state of an ACC switch to the controller 2. When the controller 2 determines, based on the IG signal or the ACC signal inputted from the key switch 19, that the IG switch is in the ON state or that the ACC switch is in the ON state, the controller 2 causes the in-vehicle communication apparatus 1 to be in a power-on state and to perform a normal operation. When the controller 2 determines, based on the IG signal or the ACC signal inputted from the key switch 19, that the IG switch is in the OFF state or that the ACC switch is in the OFF state, the controller 2 causes the in-vehicle communication apparatus 1 to be in a power-off state and to perform a low power consumption operation.

A parking brake 20 outputs a parking brake signal indicative of an ON state and an OFF state of the parking brake 20 to the controller 2.

A transmission 21 outputs a gear shift position signal indicative of gear shift position to the controller 2.

In the above example, the positioning device 5 performs autonomous positioning to acquire the vehicle position. Alternatively, the LAN transmission reception device 7 may receive the vehicle position from a navigation system (not shown) via the in-vehicle LAN 13, which navigation system acquires the vehicle position by extracting and calculating parameters from GPS signals. The vehicle position acquired by the navigation system may have higher positioning accuracy than the vehicle position acquired by the autonomous positioning of the positioning device 5, because the navigation system may utilize a vehicle speed signal, a gyro sensor detection result, an acceleration sensor result or the like and may correct the vehicle position by a map matching process.

Operation of the in-vehicle communication apparatus 1 will be described below with reference to FIG. 2. FIG. 2 is a flowchart illustrating a process to be performed by the controller 2. In the present disclosure, the meaning of a stop state of a vehicle includes not only the general meaning of a stop state of a vehicle but also a meaning of a parking state of a vehicle. For example, the meaning of a stop state of a vehicle includes not only a case where a vehicle stop time is relatively short, and the meaning of a stop state of a vehicle is not relevant to whether a vehicle stop time is relatively long or short. In the present disclosure, the meaning of a stop state of a vehicle does not include a case where a vehicle stops due to a traffic jam and a red traffic light.

When the in-vehicle communication apparatus 1 is in the power-on state, the controller 2 monitors the IG signal and the ACC signal inputted from the key switch 19, the parking brake signal inputted from the parking brake 20, the gear shift position signal inputted from the transmission 21, and the seatbelt signal, the door open/close signal and the door lock signal inputted from the body ECU 11 via the LAN transmission reception device 7. At S1, the controller 2 monitors and determines whether state of the vehicle is changed from a not-stop state (i.e., traveling state) into the stop state.

The controller 2 determines whether any one of the below-described predetermined conditions is satisfied, in order to determine whether the state of the vehicle is changed from the not-stop state (i.e., traveling state) into the stop state. When the controller 2 determines that any one of the below-described predetermined conditions is satisfied, and the controller 2 determines that the state of the vehicle is changed from the not-stop state (i.e., traveling state) into the stop state. In this case, the determination “YES” is made at S1 and the process proceeds to S2. More specifically, based on the IG signal inputted from the key switch 19, the controller 2 determines whether the IG switch is switched from ON to OFF, i.e., whether a first condition of the predetermined conditions is satisfied. Based on the ACC signal inputted from the key switch, the controller 2 determines whether the ACC switch is switched from ON to OFF, i.e., whether a second condition of the predetermined conditions is satisfied. Based on the parking brake signal inputted from the parking brake, the controller 2 determines whether the parking brake is switched from OFF to ON, i.e., whether a third condition of the predetermined conditions is satisfied. Based on the gear shift position signal inputted from the transmission 21, the controller 2 determines whether the gear shift position is changed from a range other than a parking range into the parking range, i.e., whether a fourth condition of the predetermined conditions is satisfied. Based on the seatbelt signal inputted from the body ECU 11 via the LAN transmission reception device 7, the controller 2 determines whether state of the seatbelt is changed from a fastened state into a non-fastened state, i.e., whether a fifth condition of the predetermined conditions is satisfied. Based on the door open/close signal and the door lock signal inputted from the body ECU 11 via the LAN transmission reception device 7, the controller 2 determines whether a door is locked within a predetermined time after the door is opened and then closed, i.e., whether a sixth condition of the predetermined conditions is satisfied.

At S2, the controller 2 determines whether the wireless communication between the wireless communication device 3 and the mobile communication network is possible or impossible.

For example, the controller 2 determents whether reception field strength of radio wave received with the wireless communication device 3 from the mobile communication network is greater than or equal to a threshold. When the reception field strength of the radio wave received from the mobile communication network is greater than or equal to the threshold, the controller 2 determines that the wireless communication between the wireless communication device 3 and the mobile communication network is possible. When the reception field strength of the radio wave received from the mobile communication network is less than the threshold, the controller 2 determines that the wireless communication between the wireless communication device 3 and the mobile communication network is not possible (i.e., impossible). In the above example, the controller 2 determines whether the wireless communication between the wireless communication device 3 and the mobile communication network is impossible or impossible, based on the reception field strength of the radio wave received from the mobile communication network. Alternatively, the controller 2 may acquire map information indicative of areas within and outside a communication range of the mobile communication network, and the controller 2 may compare the present vehicle position with the acquired map information, thereby determining whether the wireless communication between the wireless communication device 3 and the mobile communication network is possible or impossible. Alternatively, the controller 2 may use both of the above-described manners to determine whether the wireless communication between the wireless communication device 3 and the mobile communication network is possible or impossible.

When vehicle stop position (i.e., a place at which the vehicle is stopped) is outside the communication range of the mobile communication network or is within a radio wave faint area, and when the controller 2 determines that the reception field strength of the radio wave received from the mobile communication network is less than the threshold, the controller 2 determines that the wireless communication between the wireless communication device 3 and the mobile communication network is impossible. In this case, the determination “NO” is made at S2, and the process proceeds to S3. At S3, the controller 2 outputs the time keeping start signal to the time keeper device 4, and causes the time keeper device 4 to start time keeping. At S4, the controller 2 determines whether a prescribed time has elapsed after the output of the time keeping start signal, by monitoring the time keeping finish signal. For example, it may be preferable that the prescribed time be set smaller than a time it takes for a user to get out of the vehicle after operating the key switch 19, operating the parking brake, operating the gear shifter or unfastening the seatbelt. That is, it may be preferable that the prescribed time be set smaller than a time of user's stay in the vehicle.

When the controller 2 determines that the time keeping finish signal is inputted from the time keeper device 4 to the controller 2 and the predetermined time has elapsed, the determination “YES” is made at S4 and the process proceeds to S5. At S5, the controller 2 starts notifying notice information which indicates that the wireless communication between the wireless communication device 3 and the mobile communication network is impossible. More specifically, the controller 2 outputs the display command signal to the display device 18 to cause the display device 18 to display, for example, alarm display information indicative of “outside the communication range”, or, the controller 2 outputs the speech output command signal to the speech processing device 8 to cause the speaker 16 to output alarm speech information indicative of “outside the communication range”, or the controller 2 outputs the hazard signal from the LAN transmission reception device 7 to the body ECU 11 via the in-vehicle LAN 13 to cause the hazard lamp 14 to blink on and off. In this way, the controller 2 notifies a user that the wireless communication between the wireless communication device 3 and the mobile communication network is impossible at the vehicle stop position.

At S6, the controller 2 determines whether a condition for finishing notification of the notice information is satisfied. For example, when a prescribed time has elapsed since the controller 2 started notifying the notice information or when the operation device 17 receives a predetermined operation from a user, the controller 2 determines that the condition for finishing notification of the notice information is satisfied, and the process proceeds to S7. At S7, the controller 2 finishes (stops) notifying the notice information, and the process illustrated in FIG. 2 is ended.

In the above example, when the controller 2 determines that any one of the first to sixth conditions is satisfied, the controller 2 determines that the vehicle is in the stop state. Alternatively, the controller 2 determines whether the vehicle is in the stop state, based on a combination of two or more of the first to sixth conditions. For example, when the controller 2 determines that two or more of the first to sixth conditions is satisfied, the controller 2 may determine that the vehicle is in the stop state.

Alternatively, depending on which of the first to sixth conditions is satisfied, a manner of notifying the notice information may be selectively changed. For example, when any one of the first to fifth conditions is satisfied, it is highly likely that a user is in the compartment of the vehicle, and thus, the controller 2 may display the alarm display information or output the speech alarm information. It should be noted that, as described above, the first condition is a change of the IG switch from ON to OFF; the second condition is a change of the ACC switch from ON to OFF; the third condition is a change of the parking brake from OFF to ON; the fourth condition is a change of the gear shift position from a range other than the parking range to the parking range; the fifth condition is a change of the seatbelt from a fastened state and an fastened state. When the sixth condition, which is the unlock of a door within a predetermined time after the door is opened and closed, is the satisfied, it is highly likely that a user is outside the vehicle and is not in the compartment of the vehicle, the controller 2 may cause the hazard lamp to blink on and off. That is, a notification device may include a first notificator configured to notify the notice information to a compartment of the vehicle and a second notificator configured to notify the notice information to an outside of the vehicle. The controller 2 may causes the notification device to notify the notice information by selectively switching between notification of the notice information from the first notificator to the compartment of the vehicle, notification of the notice information from the second notificator to the outside of the vehicle, and notification of the notice information from the first notificator to the compartment of the vehicle and from the second notificator to the outside of the vehicle.

According to the first embodiment, the in-vehicle communication apparatus 1 is configured such that when it is determined that the vehicle is in the stop state and when it is determined that the wireless communication between the wireless communication device 3 and the mobile wireless communication network is impossible, the in-vehicle communication apparatus 1 displays the alarm display information or outputs the alarm speech information or causes the hazard lamp 14 to blink on and off to indicate that the vehicle stop position is within an area where the wireless communication between the wireless communication device 3 and the mobile communication network is impossible. Therefore, the in-vehicle communication apparatus 1 appropriately give a user a recognition that the vehicle stop position is within an area where the wireless communication device 3 and the mobile wireless communication network is impossible.

### Second Embodiment

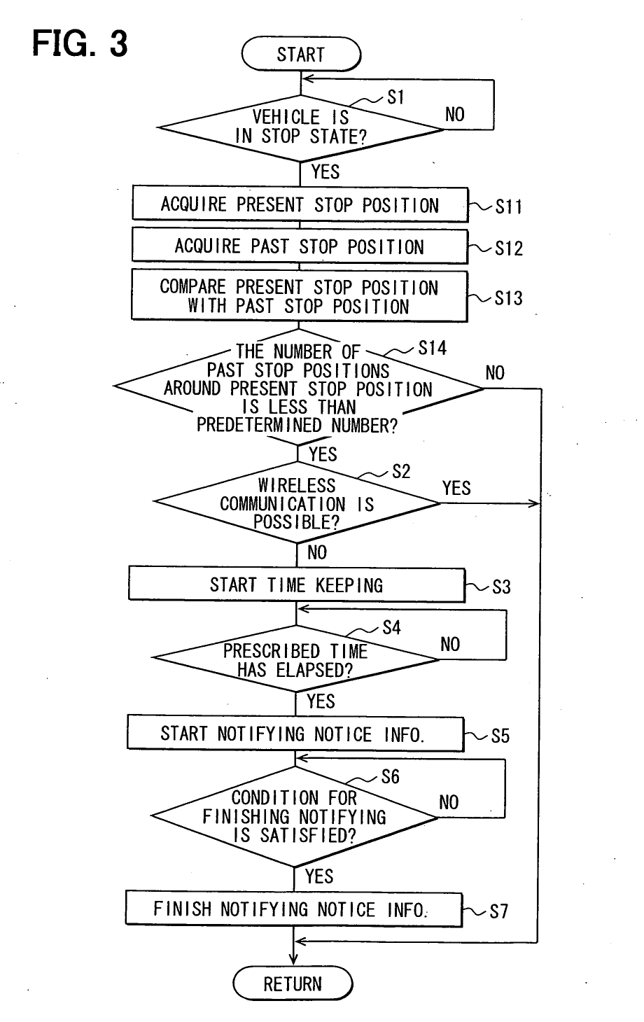

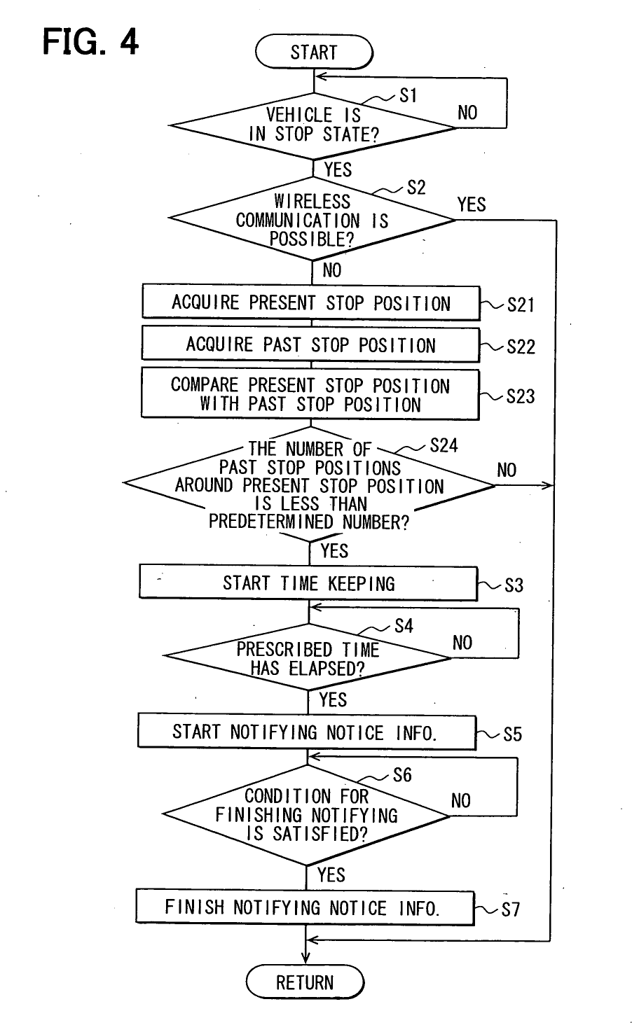

A second embodiment of the present invention will be described below with reference to FIGS. 3 and 4. In the following, description of parts or steps identical or similar to the above-described parts or steps may be omitted. In the second embodiment, the in-vehicle communication apparatus 1 determines whether there is a need to notify the notice information. When it is determined that there is a need to notify the notice information, the in-vehicle communication apparatus 1 notifies the notice information. When it is determined that there is no need to notify the notice information, the in-vehicle communication apparatus 1 does not notify the notice information. Based on a relationship between the present vehicle stop position (i.e., the stop position of the vehicle at the present time) and the past vehicle stop position (i.e., the stop position of the vehicle in past), the in-vehicle communication apparatus 1 determines whether there is a need to notify the notice information.

When the controller 2 determines at S1 that the vehicle is in the stop state, the determination “YES” is made at S1 and the process proceeds to S11. At S11, the controller 2 outputs the vehicle position acquisition signal to the positioning device 5, and acquires the latest position of the vehicle as the stop position of the vehicle at the present time. The latest position of the vehicle is, for example, the position of the vehicle located just before or just after the state of the vehicle is changed into the stop state. The above latest position of the vehicle may be also referred to as present vehicle stop position or present stop position. At S12, the controller 2 refers to the stop position in past, which is stored in the memory device 6 as the history of the vehicle position. The above stop position in past may be referred to as past vehicle stop position or past stop position. At S13, the controller 2 compares the present stop position with the past stop position. At S14, the controller 2 determines whether the relationship between the present stop position and the past stop position satisfies a predetermined condition and determines whether there a need to notify the notice information.

For example, when the controller 2 determines that the number of past stop positions within a predetermined distance radius from the present stop position, which past stop positions are stored in the memory device 6, is less than the predetermined number, the controller determines that there is a need to notify the notice information. In this case, the determination “YES” is made at S14 and the process proceeds to S2. At S2, the controller 2 determines whether the wireless communication between the wireless communication device 3 and the mobile communication network is possible. When the controller 2 determines that the wireless communication between the wireless communication device 3 and the mobile communication network is impossible, corresponding to “NO” at S2, the process proceeds to S3 and its subsequent steps. When the controller 2 determines at S14 that the number of past stop positions within a predetermined distance radius from the present stop position, which past stop positions are stored in the memory device 6, is greater than or equal to the predetermined number, the controller 2 determines that there is no need to notify the notice information. In this case, the determination “NO” is made at S14. Then, without determining whether the wireless communication between the wireless communication device 3 and the mobile communication network is possible, the process illustrated in FIG. 3 is ended.

In the above example, it is determined based on the relationship between the present stop position and the past stop position whether there is a need to notify the notice information. After it is determined that there is a need to notify the notice information, it is determined whether the wireless communication between the wireless communication device 3 and the mobile communication network is possible or impossible. Alternatively, it may be determined whether the wireless communication between the wireless communication device 3 and the mobile communication network is possible or impossible, and it may be determined based, on the relationship between the present stop position and the past stop position whether there is a need to notify the notice information after it is determined that the wireless communication between the wireless communication device 3 and the mobile communication network is impossible.

That is, as shown in FIG. 4, when the controller 2 determines that the wireless communication between the wireless communication device 3 and the mobile communication network is impossible, corresponding to “NO” at S2, the process proceeds to S21. At S21, from the positioning device 5, the controller 2 acquires the position of the vehicle as the present position of the vehicle. At S22, the controller 2 refers to the past stop position, which is stored in the memory device 6 as the history. At S23, the controller 2 compares the present stop position with the past stop position. At S24, the controller 2 determines whether the relationship between the present stop position and the past stop position satisfies a predetermined condition, and determines whether there is a need to notify the notice information.

According to the in-vehicle communication apparatus 1 of the second embodiment, when it is determined that the number of past stop positions within a predetermined distance radius from the present stop position, which past stop positions are stored in the memory device 6, is less than the predetermined number, or in other words when the vehicle is stopped within an area in which the user has not stopped the vehicle many times (e.g., a user's first visit to a travel destination), the in-vehicle communication apparatus 1 displays the alarm display information or outputs the alarm speech information or blinks on/off the hazard lamp to indicate that the wireless communication between the wireless communication device and the mobile communication networks is impossible at the present vehicle stop position. Therefore, it is possible to appropriately give a user a recognition that the vehicle stop position vehicle is within an area where the wireless communication between the wireless communication device 3 and the mobile communication network is impossible. When it is determined that the number of past stop positions within a predetermined distance radius from the present stop position stored in the memory device 6 is greater than or equal to the predetermined number, or in other words when it is determined that the vehicles is stopped within an area where the user had already stopped many times (e.g., an underground parking lot of a facility that a user frequently uses), the in-vehicle communication apparatus 1 is prohibited from notifying the notice information. Therefore, it is possible to prevent the in-vehicle communication apparatus 1 from notifying the notice information in an undesirable manner.

### Third Embodiment

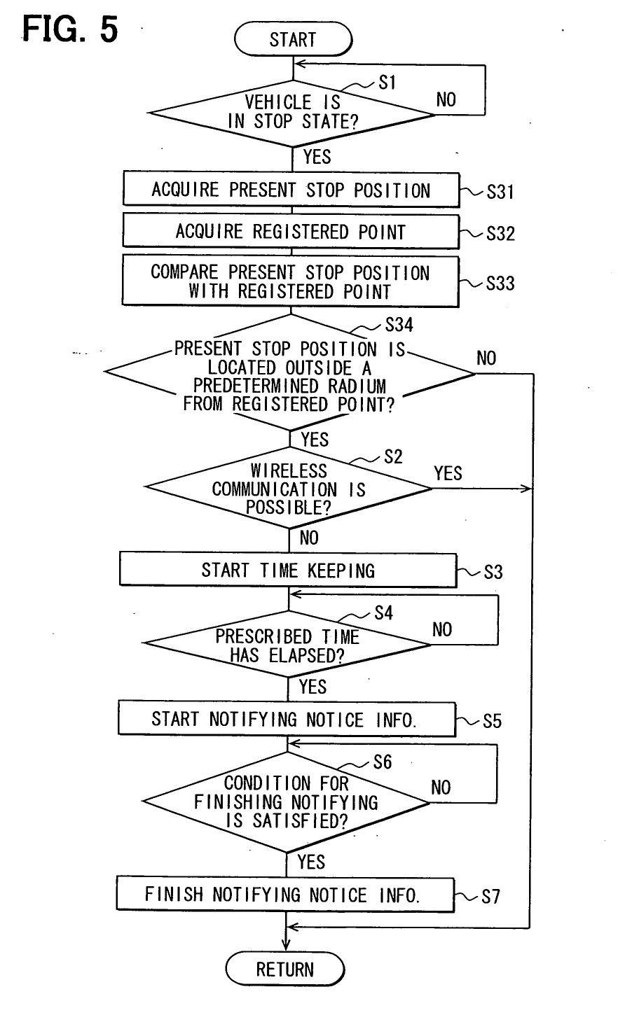

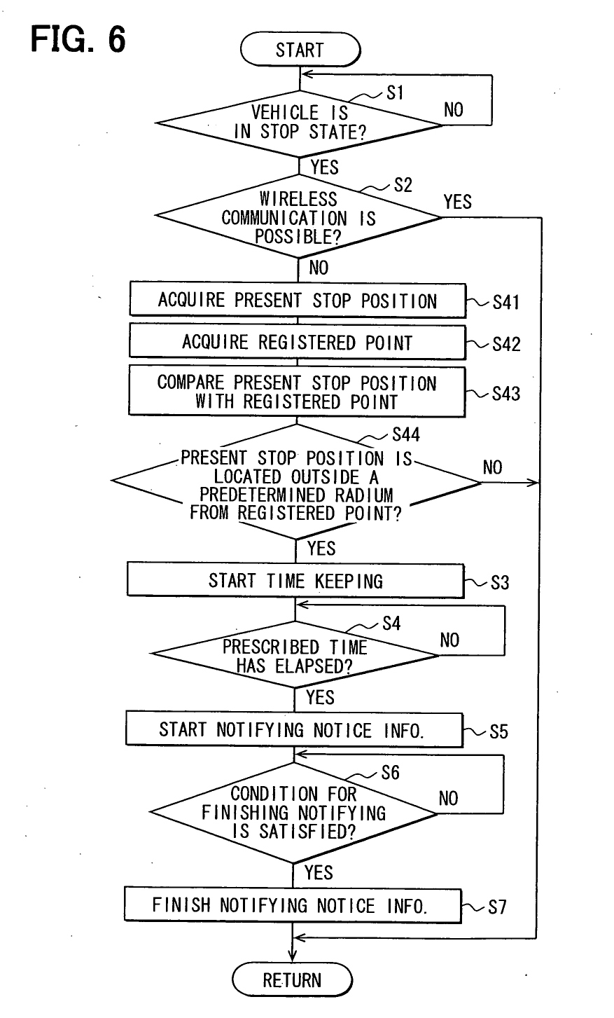

A third embodiment will be described below with reference to FIG. 5 and FIG. 6. In the following, explanation on parts or steps identical or similar to the foregoing embodiments may be omitted. In the third embodiment, based on a relationship between the present stop position and a registered point, it is determined whether there is a need to notify the notice information. The registered point may be a point previously registered by a user.

As shown in FIG. 5, when the controller 2 determines at S1 that the vehicle is in the stop state, corresponding to “YES” at S1, the process proceeds to S31. At S31, the controller 2 outputs the vehicle position acquisition signal to the positioning device 5 and acquires the present stop position, which is acquired as the vehicle position from the positioning device 5. At S32, the controller 2 refers to the registered point stored in the memory device 6. At S33, the controller 2 compares the present stop position with the registered point. At S34, the controller 2 determines whether a relationship between the present stop position and the registered point satisfies a predetermined condition, and determines whether there is a need to notify the notice information.

When the controller 2 determines that the present stop position is located outside a predetermined distance radius from the registered point, the controller 2 determines that there is a need to notify the notice information. In this case, the determination “YES” is made at S34 and the process proceeds to S2. At S2, the controller 2 determines whether the wireless communication between the wireless communication device 3 and the mobile communication network is possible. When the controller 2 determines that the wireless communication between the wireless communication device 3 and the mobile communication network is not possible, corresponding to “NO” at S2, the process proceeds to S3 and its subsequent steps are performed. When the controller 2 determines that the present stop position is located within a predetermined distance radius from the registered point, the controller 2 determines that there is no need to notify the notice information. In this case, the determination “NO” is made at S34. Then, without determining whether the wireless communication between the wireless communication device 3 and the mobile communication network is possible, the process illustrated in FIG. 5 is ended.

Alternatively, it may be determined whether the wireless communication between the wireless communication device 3 and the mobile communication network is possible or impossible, and it may be determined based on the relationship between the present stop position and the registered point whether there is a need to notify the notice information after it is determined that the wireless communication between the wireless communication device 3 and the mobile communication network is not possible.

More specifically, as shown in FIG. 6, when it is determines that the wireless communication between the wireless communication device 3 and the mobile communication network is not possible, corresponding to “NO” at S2, the process proceeds to S41. At S41, from the positioning device 5, the controller 2 acquires the present stop position. At S42, the controller 2 refers to the registered point stored in the memory device 6. At S43, the controller 2 compares the present stop position with the registered point. At S44, the controller 2 determines whether a relationship between the present stop position and the registered point satisfies the predetermined condition, and determines whether there is a need to notify the notice information.

According to the third embodiment, the in-vehicle communication apparatus 1 is configured such that when it is determined that the present stop position is located outside of a predetermined distance radius from the registered point previously registered by a user, the in-vehicle communication apparatus 1 displays the alarm display information or outputs the alarm speech information or blinks on/off the hazard lamp 14 to indicate that the vehicle stop position is within an area where the wireless communication between the wireless communication device 3 and the mobile communication network is impossible. When it is determined that the present stop position is located within a predetermined distance radius from the registered point previously registered by a user, the in-vehicle communication apparatus 1 is prohibited from notifying the notice information. Therefore, it is possible to prevent the in-vehicle communication apparatus 1 from notifying the notice information in an undesirable manner.

### Fourth Embodiment

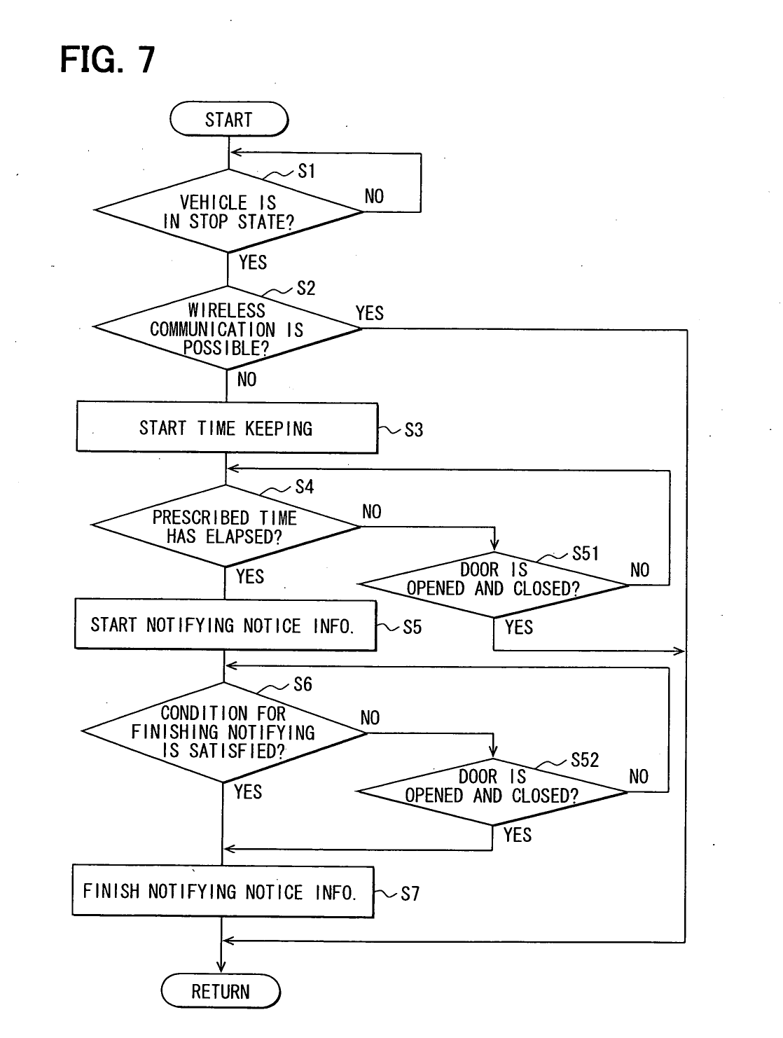

A fourth embodiment will be described below with reference to FIG. 7. In the following, explanation on parts or steps identical or similar to the above-described embodiments may be omitted. In the fourth embodiment, based on opening and closing of the door, it is determined whether there is a need to notify the notice information.

As shown in FIG. 7, when the controller 2 determines that the vehicle is in the stop state, corresponding to “YES” at S1, the process proceeds to S2. When the controller 2 determines that the wireless communication between the wireless communication device 3 and the mobile communication network is not possible, corresponding to “NO” at S2, the process proceeds to S3. At S3, the controller 2 causes the time keeper device 4 to start time keeping. At S4 and S5, the controller 2 determines whether a prescribed time has elapsed, and determines whether the door is opened and closed based on the door open/close signal inputted from the body. ECU 11 via the LAN transmission reception device 7.

When the controller 2 determines that the prescribed time has elapsed prior to the opening and closing of the door (i.e., during elapse of the prescribed time, the door is not opened and closed), corresponding to “YES” at S4, the process proceeds to S5 and its subsequent steps to display the alarm display information, output the alarm speech information or blink on/off the hazard lamp 14. When the controller 2 determines that the door is opened and closed prior to the elapse of the prescribed time, the process illustrated in FIG. 7 is ended without displaying the alarm display information, without outputting the alarm speech information and without blinking on/off the hazard lamp 14.

At S5, the controller 2 starts notifying the notice information indicating that the wireless communication between the wireless communication device 3 and the mobile communication network is not possible. At S6 and S52, the controller 2 determines whether a condition for finishing notification of the notice information is satisfied, and determines whether the door is opened and closed based on the door open/close signal inputted from the body ECU 11 via the LAN transmission reception device 7.

When the controller 2 determines that the condition for finishing notifying the notice information is satisfied prior to the opening and closing of the door, corresponding to “YES” at S6, the process proceeds to S7. At S7, the controller 2 finishes notifying the notice information indicating that the wireless communication between the wireless communication device 3 and the mobile communication network is not possible. Then, the process illustrated in FIG. 7 is ended. When the controller 2 determines that the door is opened and closed prior to satisfaction of the condition for finishing notifying the notice information, corresponding to “YES” at S52, the process proceeds to S7. At S7, the controller 2 finishes (i.e., stops) notifying the notice information, and the process illustrated in FIG. 7 is ended.

According to the fourth embodiment, the in-vehicle communication apparatus 1 is configured such that when it is determines that the door is opened and closed, the notice information is prohibited from being notified. Therefore, it is possible to prevent the in-vehicle communication apparatus 1 from notifying the notice information in an undesirable manner. It is possible to prevent a third person (i.e., third party) around the vehicle from becoming aware that the vehicle stop position is within an area where the wireless communication between the wireless communication device 3 and the mobile communication network is not possible. It is therefore possible, to enhance security. Moreover, according to the present embodiment, the in-vehicle communication apparatus 1 is configured such that when it is determined that the door is opened and closed during the notification of the notice information, the notification of the notice information is stopped prior to the satisfaction of the condition for finishing notifying the notice information. Therefore, the notification of the notice information in an undesirable manner after the opening and closing of the door can be prevented. It is possible to enhance security.

### Fifth Embodiment

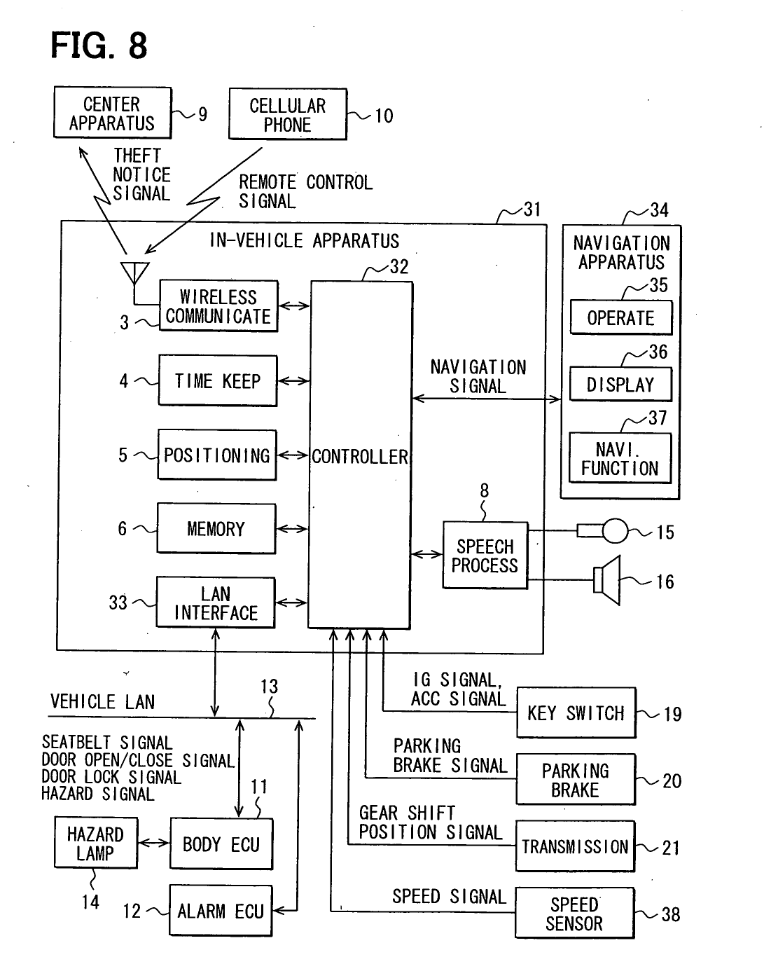

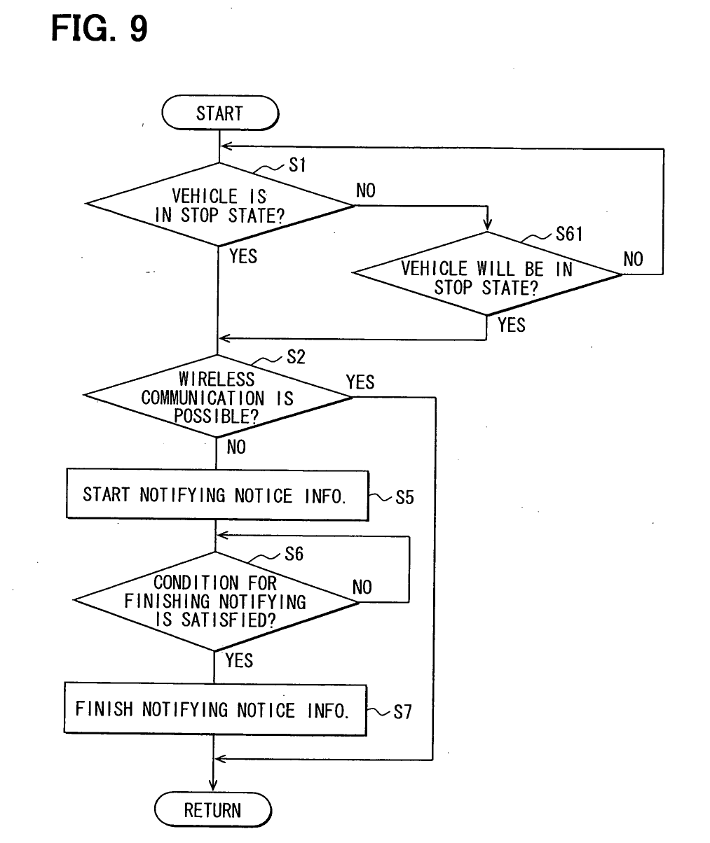

A fifth embodiment will be described below with reference to FIGS. 8 and 9. In the following, explanation on parts or steps identical or similar to the foregoing embodiments may be omitted. In the fifth embodiment, in addition to monitoring whether the state of the vehicle is changed from the not-stop state into the stop state, an in-vehicle communication apparatus 31 performs monitoring whether there is a possibility that the vehicle will be in the stop state, or in other words monitoring whether the vehicle is expected to be in the stop state. When it is determined that the vehicle is expected to be in the stop state, the in-vehicle communication apparatus 1 notifies the notice information.

The in-vehicle communication apparatus 31 is mountable to the vehicle. In addition to the wireless communication device 3, the time keeper device 4, the positioning device 5, the memory device 6 and the speech processing device 8 already illustrated in the first embodiment, the in-vehicle communication apparatus 31 includes a controller 32 and a LAN transmission reception device 33. The controller 32 can act as a vehicle stop state determination portion or section, a connectibility determination portion or section, a control portion or section, a vehicle stop possibility determination portion or section.

The controller 32 includes a microcomputer as a main component. The microcomputer includes a CPU, a RAM and a ROM. The controller 32 controls generally all of operations of the in-vehicle communication apparatus 31. The LAN transmission reception device 33 is connected with various ECUs and systems mounted to the vehicle via the in-vehicle LAN 13. For example, the LAN transmission reception device 33 is connected with the body ECU, the alarm ECU and the like. In the present embodiment, when the LAN transmission reception device 33 receives the seatbelt signal, the door open/closes signal or the door lock signal via the in-vehicle LAN 13 as illustrated in the first embodiment, the controller 32 outputs the seatbelt signal, the door open/closes signal or the door lock signal to the controller 32. When the LAN transmission reception device 33 receives a hazard blink signal, which indicates whether the hazard lamp 14 is in a blink state, from the hazard lamp 14, the LAN transmission reception device 33 outputs the hazard blink signal to the controller 32.

A navigation apparatus 34 includes an operation device 35, a display device 36 and a navigation function device 37. The operation device 35 and the display device 36 have functions that are identical or similar to functions of the operation device 17 and the display device 18 illustrated in the first embodiment. The navigation function device 37 performs processing relating to a navigation function. A navigation signal indicative of information on the navigation function is inputted and outputted between the navigation apparatus 34 and the controller 32. The navigation function includes a function to locate the present position of the vehicle, a function to set a destination, a function to retrieve a route from the present position of the vehicle to the destination, a function to superimpose the present position of the vehicle or the route on the map, a function to predict an arrival time to the destination in accordance with the retrieved route, a function to perform route guidance, and the like. A vehicle speed sensor 38 outputs a vehicle speed signal indicative of speed of the vehicle to the controller 32.

As shown in FIG. 9, at S1, the controller 32 of the in-vehicle communication apparatus 31 monitors whether the state of the vehicle is changed from the not-stop state into the stop state. When the controller 32 determines that the state of the vehicle is not changed into the stop state, corresponding to “NO” at S1, the process proceeds to S61. At S61, the controller 32 determines whether the vehicle is expected to be in the stop state.

To determine whether the vehicle is expected to be in the stop state, the controller 32 may determine whether any one of predetermined conditions is satisfied. More specifically, To determine whether a first one of the predetermined conditions is satisfied, the controller 32 determines, based on the IG signal inputted from the key switch 19 and the gear shift position signal inputted from the transmission 21, whether the gear shift position is changed into a reverse range after the predetermined time has elapsed since the IG switch was switched from OFF to ON. To determine whether a second one of the predetermined conditions is satisfied, the controller 32 determines, based on the hazard blink signal inputted from hazard lamp 14, whether the hazard lamp is tuned off after the hazard lamp 14 blinks on and off for a predetermined time. To determine whether a third one of the predetermined conditions is satisfied, the controller 32 determines, based on the navigation signal, determines whether the vehicle approaches the destination. For example, the controller 32 determines whether the present position of the vehicle approaches within a predetermined distance radius from the destination, or whether a distance between the present position of the vehicle and the destination along the route becomes equal to or less than a predetermined distance. To determine whether a fourth one of the predetermined conditions is satisfied, the controller 32 determines, based on the navigation signal inputted from the navigation apparatus 34 and the vehicle speed signal inputted from the vehicle speed sensor 38, whether road type at the present position of the vehicle is parking lot and the speed of the vehicle is zero. When the controller 32 determines that any one of the predetermined conditions is satisfied and determines that the vehicle is expected to be in the stop state, corresponding to “YES” at S61, the process proceeds to S2. At S2, the controller 32 determines whether the wireless communication between the wireless communication device 3 and the mobile communication network is possible. When the controller 32 determines that the wireless communication between the wireless communication device 3 and the mobile communication network is not possible, corresponding to “NO” at S2, the process proceeds to S5 and its subsequent steps in a manner similar that illustrated in the first embodiment.

At a time when the controller 32 determines that the vehicle is expected to be in the stop state, it is highly likely that a user is in the compartment of the vehicle. In this case, the in-vehicle communication apparatus 31 displays the alarm display information or outputs the alarm speech information. However, unlike the first embodiment, the in-vehicle communication apparatus 31 does not need to blink on and off the hazard lamp 14. Moreover, unlike the first embodiment, after the controller determines that the wireless communication between the wireless communication device 3 and the mobile communication network is not possible, the controller 32 does not determines whether the predetermined time has elapsed but starts notifying the notice information indicating that the wireless communication between the wireless communication device 3 and the mobile communication network is not possible.

According to the fifth embodiment, when the controller 32 determines that the vehicle is expected to be in the stop state and when the controller 32 determines that the wireless communication between the wireless communication device 3 and the mobile communication network is not possible, the in-vehicle communication apparatus 31 displays the alarm display information or outputs the alarm speech information to indicate that a place at which the vehicle is expected to stop is within an area where the wireless communication between the wireless communication device 3 and the mobile communication network is not possible. Therefore, it is possible to appropriately give a user a recognition that a place at which the vehicle is expected to stop is within an area where the wireless communication between the wireless communication device 3 and the mobile communication network is not possible. In other words, when the notice information is notified after the vehicle is stopped, a user may need to restart the vehicle (e.g., restart the engine) after the user receives the notice information and gets an idea of stopping the vehicle within the communication range of the mobile communication network. In this case, an operation for restarting the vehicle may be bothersome for a user. When the notice information is notified before the vehicle is stopped, a user may not need to restart the vehicle and the user can stop the vehicle within the communication range of the mobile communication network.

### Other Embodiments

Embodiments of the present invention are not limited to the above-described embodiments. The above-described embodiments can be modified or extended in various ways, examples of which will be described below. In addition to transmission of the theft notice signal to the center apparatus via the mobile communication network in response to a determination of occurrence of vehicle theft, the in-vehicle communication apparatus may transmit an abnormality notice signal to the center apparatus via the mobile communication network when it is determined that an abnormality takes place. For example, when a window is destroyed or when a main body of the navigation apparatus is fraudulently removed, the in-vehicle communication apparatus may transmit an abnormality notice signal to the center apparatus via the mobile communication network. Moreover, the wireless communication device 3 may transmit and receive a signal other than the above-described signals via the mobile communication network.

To determine whether the vehicle is in the stop state, it may be determined whether the door is opened. In this case, when it is determined that the door is opened, it may be determined that the state of the vehicle is changed from the not-stop state into the stop state. To determine whether the vehicle is in the stop state, a seat signal or a video signal may be used. The seat signal may be outputted from a seat sensor configured to detect whether a user is sitting on a seat. The video signal may be outputted from an in-vehicle camera configured to image a user. To notify the notice information indicating that the wireless communication between the wireless communication device 3 and the mobile communication network is not possible at the vehicle stop position, headlights may be blinked on and off or a horn may be sounded.

In the second embodiment, the present stop position and the past stop position are compared. In this case, the past stop position to be compared, with the present stop position may be such one or ones that was recorded in the memory device 6 recently (e.g., after a predetermined date). The past stop position recorded in the memory device 6 in old days (e.g., before the predetermined date) may not compared with the present stop position and may be excluded from a comparison target.

In the third embodiment, the present stop position and the registered point are compared. In this case, the registered point to be compared with the present stop position may be such one or ones that was recorded in the memory device 6 recently (e.g., after a predetermined date). The registered point recorded in, the memory device 6 in old days (e.g., before the predetermined date) may not compared with the present stop position and may be excluded from a comparison target.

In the fourth embodiment, when the door is at least opened and even not be closed, the in-vehicle communication apparatus may then prohibit the alarm display information from being displayed, the alarm speech information from being outputted, and the hazard lamp 14 from being blinked on and off.

In the fifth embodiment, a situation in which the vehicle is in the stop state may be recorded as a history in the memory device 6. For example, a history of vehicle stop position, vehicle stop frequency, vehicle stop data and the like may be stored. By referring to the history, the in-vehicle communication apparatus may determine whether the vehicle is expected to be in the stop state. In the fifth embodiment, the vehicle speed signal from the vehicle speed sensor 38 may be directly inputted to the controller 32. Alternatively, the vehicle speed signal from the vehicle speed sensor 38 may be inputted to the controller 32 via the in-vehicle LAN 13.

(Aspects)

The present disclosure includes the following aspects.

According to an aspect an in-vehicle communication apparatus is provided. The in-vehicle communication apparatus includes: a wireless communication device configured to perform wireless communication via a mobile communication network; a vehicle stop state determination section configured to determine whether a vehicle is in a stop state or a not-stop state; a connectibility determination section configured to determine whether the wireless communication between the wireless communication device and the mobile communication network is possible or impossible; and a control section configured to cause a notification device to notify notice information when the vehicle stop state determination section determines that the vehicle is in the stop state and when the connectibility determination section determines that the wireless communication between the wireless communication device and the mobile communication network is impossible. The notice information indicates that position of the vehicle in the stop state is within an area where the wireless communication between the wireless communication device and the mobile communication network is impossible.

According to the above in-vehicle communication apparatus, when vehicle stop position is outside a communication range of the mobile communication network or is within an poor reception environment area (e.g., a weak radio wave area), the notification device can notify the notice information indicating that the position of the vehicle in the stop state is within an area where the wireless communication between the wireless communication device and the mobile communication network is impossible. Therefore, it is possible to appropriately give a user a recognition that the wireless communication between the wireless communication device and the mobile communication network is impossible at the position of the vehicle in the stop state.

The above in-vehicle communication apparatus may be configured in the following way. The notification device includes a first notificator configured to notify the notice information to an inside of the vehicle and a second notificator configured to notify the notice information to an outside of the vehicle. The control section causes the notification device to notify the notice information by selectively switching between (i) notification of the notice information from the first notificator to the inside of the vehicle, (ii) notification of the notice information from the second notificator to the outside of the vehicle, and (iii) notification of the notice information from the first notificator to the inside of the vehicle and from the second notificator to the outside of the vehicle.

According to the above configuration, when a user is possibly in the inside of the vehicle or when the notification of the notice information to an outside of the vehicle may possibly, cause disadvantage for a user, the in-vehicle communication apparatus can notify the notice information to only the inside of the vehicle. When a user is possibly outside the vehicle, or when the notification of the notice information to an outside of the vehicle may not cause disadvantage for a user, the in-vehicle communication apparatus can notify the notice information to only the outside of the vehicle. When it is uncertain whether a user is inside or outside the vehicle, or when the notification of the notice information to an outside of the vehicle may not cause disadvantage for a user, the in-vehicle communication apparatus can notify the notice information to both of the inside of the vehicle and the outside of the vehicle. In this way, while user behavior or environment is being took into account, it is possible to appropriately give a user a recognition that the wireless communication between the wireless communication device and the mobile communication network is impossible at the position of the vehicle in the stop state.

The above in-vehicle communication apparatus may be configured in the following way. The control section determines whether there is a need to notify the notice information from the notification device. When the control section determines that there is the need to notify the notice information from the notification device, the control section causes the notification device to notify the notice information. When the control section determines that there is no need to notify the notice information from the notification device, the control section prohibits the notification device from notifying the notice information.

According to the above configuration, the in-vehicle communication apparatus can notify the notice information when it is highly conceivable that, for example, a user is not aware that the wireless communication between the wireless communication device and the mobile communication network is impossible, or when the notification of the notice information to an outside of the vehicle may not cause disadvantage for a user. Thereby, the in-vehicle communication apparatus can appropriately give a user a recognition that the wireless communication between the wireless communication device and the mobile communication network is impossible at the position of the vehicle in the stop state. Moreover, the in-vehicle communication apparatus can prohibit the notification of the notice information when it is highly conceivable that, for example, a user is aware that the wireless communication between the wireless communication device and the mobile communication network is impossible, or when the notification of the notice information to an outside of the vehicle may cause disadvantage for a user. Therefore, it is possible to prevent the notice information from being notified in an undesirable manner.

The above in-vehicle communication apparatus may further include a vehicle position acquisition section configured to acquire the position of the vehicle and a vehicle position history storage section configured to store the position of the vehicle acquired by the vehicle position acquisition section as a history of the position of the vehicle. The control section may determine whether a relationship between the position of the vehicle at a present time, which is acquired by the vehicle position acquisition section, and the position of the vehicle in past, which is stored as the history in the vehicle position history storage section, satisfies a predetermined condition. When the control section determines that the relationship between the position of the vehicle at the present time and the position of the vehicle in past satisfies the predetermined condition, the control section may determine that there is the need to notify the notice information from the notification device. When the control section determines that the relationship between the position of the vehicle at the present time and the position of the vehicle in past does not satisfy the predetermined condition, the control section may determine that there is no need to notify the notice information from the notification device.

According to the above configuration, the in-vehicle communication apparatus can notify the notice information when the number of past vehicle stop positions located within a predetermined distance radius form the present vehicle stop position, which past vehicle stop positions are stored as the history, is less than a predetermined number for example, or in others words when the vehicle is stopped in an area at which a user has not stopped the vehicle many times (e.g., a user's first visit to a travel destination). Therefore, it is possible to appropriately give a user a recognition that the wireless communication between the wireless communication device and the mobile communication network is impossible at the position of the vehicle in the stop state. When the number of past vehicle stop positions located within the predetermined distance radius form the present vehicle stop position is greater than or equal to the predetermined number, or in other words when the vehicle is stopped in an area at which a user has stopped the vehicle many times (e.g., an underground parking lot of a facility that a user frequently uses), it is possible to prohibit the notice information from being notified. Therefore, it is possible to prevent the notice information from being notified in an undesirable manner.

The above in-vehicle communication apparatus may further include a vehicle position acquisition section configured to acquire the position of the vehicle and a registered point storage section configured to store a registered point, which is inputted via an operation device that is operable by a user to register an arbitrary point as the registered point. The control section may determine whether a relationship between the position of the vehicle at a present time, which is acquired by the vehicle position acquisition section, and the registered point, which is stored in the registered point storage section, satisfies a predetermined condition. When the control section determines that the relationship between the position of the vehicle at the present time and the registered point satisfies the predetermined condition, the control section may determine that there is the need to notify the notice information from the notification device. When the control section determines that the relationship between the position of the vehicle at the present time and the registered point does not satisfy the predetermined condition, the control section may determine that there is no need to notify the notice information from the notification device.

According to the above configuration, the in-vehicle communication apparatus can notify the notice information when present stop position of the vehicle is located outside a predetermined distance radius from the registered point previously registered by a user, and thereby the in-vehicle communication apparatus can appropriately give a user a recognition that the wireless communication between the wireless communication device and the mobile communication network is impossible at the position of the vehicle in the stop state. When present stop position of the vehicle is located within a predetermined distance radius from the registered point previously registered by a user, the in-vehicle communication apparatus can prohibit the notice information from being notified. Therefore, it is possible to prevent the notice information from being notified in an undesirable manner.

The above in-vehicle communication apparatus may be configured in the following way. The control section determines whether a door of the vehicle, which door allows a user to get into and out of the vehicle, is at least opened or closed. When the control section determines that the door is at least opened or closed, the control section determines that there is no need to notify the notice information.

According to the above configuration, when the door is at least opened or closed, or in other words when it is highly likely that a user gets away from the vehicle, the in-vehicle communication apparatus can prohibit the notice information from being notified. Therefore, it is possible to prevent the notice information from being notified in an undesirable manner. Moreover, it is possible to prevent a third party from becoming aware that the wireless communication between the wireless communication device and the mobile communication network is impossible at the position of the vehicle in the stop state. It is possible to enhance security.

The above in-vehicle communication apparatus may be configured such that when the control section determines that there is a need to stop notifying the notice information during notification of the notice information from the notification device, the control section causes the notification device to stop notifying the notice information. According to this configuration, since it is possible to stop notifying the notice information, it is possible to prevent the notice information from being notified in an undesirable manner.

The above in-vehicle communication apparatus may be configured in the following way. When the control section determines that a door of the vehicle, which door allows a user to get into and out of the vehicle, is at least opened or closed, the control section determines that there is the need to stop notifying the notice information.

According to the above configuration, when the door is at least opened or closed during the notification of the notice information, or in other words when it is highly likely that the vehicle gets away from the vehicle, it is possible to stop notifying the notification information, and it is possible to prevent the notice information from being notified in an undesirable manner. Moreover, it is possible to prevent a third party from becoming aware that the wireless communication between the wireless communication device and the mobile communication network is impossible at the position of the vehicle in the stop state. It is possible to enhance security.

The above in-vehicle communication apparatus may further include a vehicle stop possibility determination section configured to determine whether the vehicle is expected to be in the stop state. When the vehicle stop possibility determination section determines that the vehicle is expected to be in the stop state, and when the connectibility determination section determines that the wireless communication between the wireless communication device and the mobile communication network is impossible, the control section may cause the notification device to notify the notice information to indicate that the wireless communication between the wireless communication device and the mobile communication network is impossible in an area at which the vehicle is expected to be in the stop state.

According to the above configuration, the notification device can notify the notice information when an expected vehicle stop place (i.e., a place at which the vehicle is expected to be in the stop state) is outside the communication range of the mobile communication network or is within the poor reception environment area. Thereby, it is possible to appropriately give a user a recognition that the expected vehicle stop place is within an area where the wireless communication between the wireless communication device and the mobile communication network is impossible. When a user would like to stop the vehicle within the communication range of the mobile communication network, the in-vehicle communication apparatus can appropriately inform the user of whether the expected vehicle stop place is within or outside the communication range of the mobile communication network. It should be noted that when the notice information is notified after the vehicle is stopped, a user may need to restart the vehicle (e.g., restart the engine) upon receiving the notice information indicating that the vehicle is stopped outside the communication range of the mobile communication network. In this case, an operation for restarting the vehicle may be bothersome for a user. According the above configuration, by contrast, since the in-vehicle communication apparatus can notify the notice information before the vehicle is stopped, a user may not need to restart the vehicle and the user can stop the vehicle within the communication range of the mobile communication network.

While the invention has been described above with reference to various embodiments thereof, it is to be understood that the invention is not limited to the above described embodiments and construction. The invention is intended to cover various modification and equivalent arrangements. In addition, while the various combinations and configurations described above are contemplated as embodying the invention, other combinations and configurations, including more, less or only a single element, are also contemplated as being within the scope of embodiment.

What is claimed is:

1. An in-vehicle communication apparatus comprising:
a wireless communication device configured to perform wireless communication via a mobile communication network;
a vehicle stop state determination section configured to determine whether a vehicle is in a stop state or a not-stop state;
a connectibility determination section configured to determine whether the wireless communication between the wireless communication device and the mobile communication network is possible or impossible; and
a control section configured to cause a notification device to notify notice information when the vehicle stop state determination section determines that the vehicle is in the stop state and when the connectibility determination section determines that the wireless communication between the wireless communication device and the mobile communication network is impossible, the notice information indicating that position of the vehicle in the stop state is within an area where the wireless communication between the wireless communication device and the mobile communication network is impossible.

2. The in-vehicle communication apparatus according to claim 1, wherein:
the notification device includes a first notificator configured to notify the notice information to an inside of the vehicle and a second notificator configured to notify the notice information to an outside of the vehicle; and
the control section causes the notification device to notify the notice information by selectively switching between
notification of the notice information from the first notificator to the inside of the vehicle,
notification of the notice information from the second notificator to the outside of the vehicle, and
notification of the notice information from the first notificator to the inside of the vehicle and from the second notificator to the outside of the vehicle.

3. The in-vehicle communication apparatus according to claim 1, wherein:
the control section determines whether there is a need to notify the notice information from the notification device;
when the control section determines that there is the need to notify the notice information from the notification device, the control section causes the notification device to notify the notice information; and
when the control section determines that there is no need to notify the notice information from the notification device, the control section prohibits the notification device from notifying the notice information.

4. The in-vehicle communication apparatus according to claim 3, further comprising:
a vehicle position acquisition section configured to acquire the position of the vehicle; and
a vehicle position history storage section configured to store the position of the vehicle acquired by the vehicle position acquisition section as a history of the position of the vehicle,
wherein:
the control section determines whether a relationship between the position of the vehicle at a present time, which is acquired by the vehicle position acquisition section, and the position of the vehicle in past, which is stored as the history in the vehicle position history storage section, satisfies a predetermined condition;
when the control section determines that the relationship between the position of the vehicle at the present time and the position of the vehicle in past satisfies the predetermined condition, the control section determines that there is the need to notify the notice information from the notification device; and
when the control section determines that the relationship between the position of the vehicle at the present time and the position of the vehicle in past does not satisfy the predetermined condition, the control section determines that there is no need to notify the notice information from the notification device.

5. The in-vehicle communication apparatus according to claim 3, further comprising:
a vehicle position acquisition section configured to acquire the position of the vehicle; and
a registered point storage section configured to store a registered point, which is inputted via an operation device that is operable by a user to register an arbitrary point as the registered point;
wherein:
the control section determines whether a relationship between the position of the vehicle at a present time, which is acquired by the vehicle position acquisition section, and the registered point, which is stored in the registered point storage section, satisfies a predetermined condition;
when the control section determines that the relationship between the position of the vehicle at the present time and the registered point satisfies the predetermined condition, the control section determines that there is the need to notify the notice information from the notification device; and
when the control section determines that the relationship between the position of the vehicle at the present time and the registered point does not satisfy the predetermined condition, the control section determines that there is no need to notify the notice information from the notification device.

6. The in-vehicle communication apparatus according to claim 3, wherein:
the control section determines whether a door of the vehicle, which door allows a user to get into and out of the vehicle, is at least opened or closed; and
when the control section determines that the door is at least opened or closed, the control section determines that there is no need to notify the notice information.

7. The in-vehicle communication apparatus according to claim 1, wherein:
when the control section determines that there is a need to stop notifying the notice information during notification of the notice information from the notification device, the control section causes the notification device to stop notifying the notice information.

8. The in-vehicle communication apparatus according to claim 7, wherein:
when the control section determines that a door of the vehicle, which door allows a user to get into and out of the vehicle, is at least opened or closed, the control section determines that there is the need to stop notifying the notice information.

9. The in-vehicle communication apparatus according to claim 7, further comprising:
a vehicle stop possibility determination section configured to determine whether the vehicle is expected to be in the stop state;
wherein:
when the vehicle stop possibility determination section determines that the vehicle is expected to be in the stop state, and when the connectibility determination section determines that the wireless communication between the wireless communication device and the mobile communication network is impossible, the control section causes the notification device to notify the notice information to indicate that the wireless communication between the wireless communication device and the mobile communication network is impossible in an area at which the vehicle is expected to be in the stop state.
